(19) United States
(12) Patent Application Publication
(10) Pub. No.: US 2003/0066076 A1
(43) Pub. Date: Apr. 3, 2003

(54) Method of distribution of digital media having durational limits for digital media usage

(76) Inventor: Michael R. Minahan, Portland, OR (US)

Correspondence Address: Pillsbury Winthrop LLP, Intellectual Property Group, Suite 2800, 725 So. Figueroa Street, Los Angeles, CA, 90017-5406, US

(21) Appl. No.: 09/967,643

(22) Filed: Sep. 28, 2001

(51) Int. Cl. H04N 7/16; H04L 9/00; H04N 7/167

(52) U.S. Cl. 725/29; 725/25; 725/23; 380/210; 713/150; 380/229; 380/227

(57) ABSTRACT

A digital media distribution system includes a distribution center and an utilization device that communicates with, and receives digital media from, the distribution center. Restrictions are transferred with the digital media that limit the use of the digital media on the utilization device independently of the distribution center.

### BACKGROUND OF THE INVENTION

1. Field of the Invention

The present invention generally relates to digital media distribution. More particularly, the present invention relates to distribution methods for digital media having durational limits for digital media usage.

2. Discussion of the Related Art

Music, television programming, movies, games, and information are increasingly being stored and transferred in digital format. Digital media provides easier access and faster transfers for consumers to receive their desired entertainment or information. Therefore, convenient delivery and utilization of digital media are important for consumer satisfaction.

Currently, digital media consumption is restricted by controlling content distribution. Consumers can purchase or rent some forms of digital media, but in these situations consumption remains dependent upon the method of distribution. Examples of this distribution method include the purchasing of a CD music album from a retail store and the renting of a DVD movie from a video rental store. Digital media service providers charge consumers for unlimited access for certain time periods or for particular activities consumers undertake while in communication with the service provider. Examples of this method include charging consumers for unlimited Internet access for a month, for digital cable television programming for a month, for use of a particular database for a monitored period of time, and for discrete applications of a particular Internet website. These methods of consumption are also directly controlled by the distribution techniques because the consumer's activities are monitored by the service provider. Consumers are charged to get content, not use content. Therefore, the ability to use digital media content independent of the acquisition of the content is desirable for consumer convenience.

The opportunity to access digital media independent of distribution constraints provides many benefits to consumers and distributors. Consumers may not be able to sample a particular product without purchasing it; therefore, consumers would prefer limited access to a product before the commitment of purchasing the item. Consumers may also want to utilize the product without time and location constraints required to facilitate the billing of a consumer in, for example, the downloading and use of digital music and video. These types of conveniences may be provided to improve consumer satisfaction.

### BRIEF DESCRIPTION OF THE DRAWINGS

FIG. 1 illustrates a digital media distribution system according to an embodiment of the present invention;

FIG. 2 illustrates a sample operation of a distribution of digital media as illustrated in FIG. 1 where the digital media is transferred from a Digisource to a Digibase; and

FIG. 3 illustrates a sample operation of a distribution of digital media as illustrated in FIG. 1 where the digital media is transferred from a first Digibase to a second Digibase.

### DETAILED DESCRIPTION

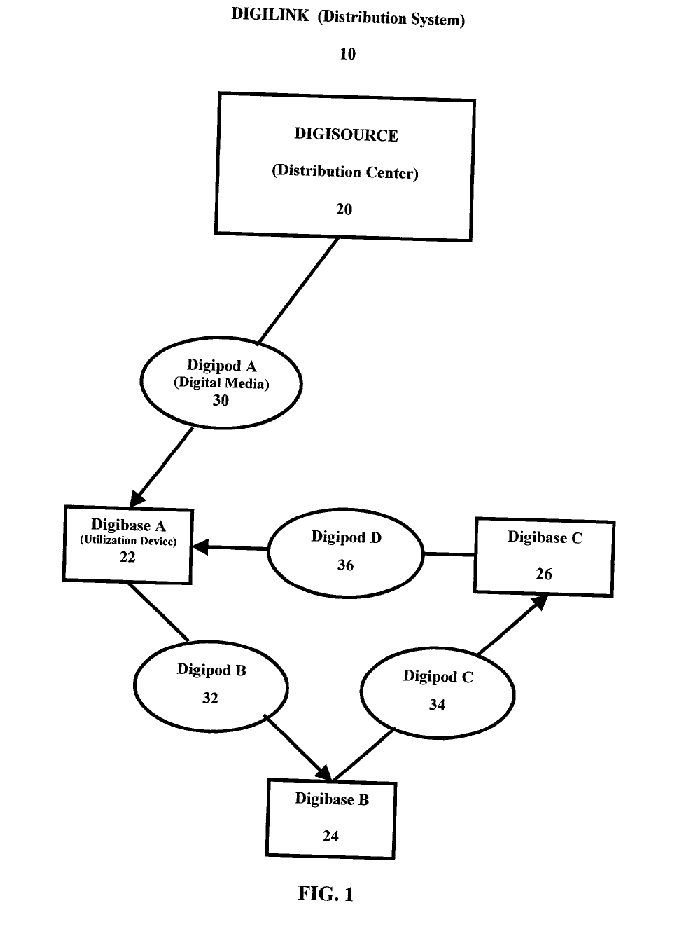

FIG. 1 illustrates a distribution system for digital media according to an embodiment of the present invention. The distribution system, or Digilink 10, includes a distribution center 20 that stores and distributes various forms of digital media is known as a Digisource 20. To transfer the digital media 30, along with the restrictions on the use of the digital media 30, the Digisource 20 uses a software application known as a Digipod A 30. The recipient of a Digipod A 30 is a utilization device 22 known as a Digibase A 22 that is a hardware platform programmed to accept and utilize the digital media and restrictions provided by the Digipod A 30. FIG. 1 also illustrates how Digibases are capable of transferring digital media and restrictions amongst themselves, independently of Digisource 20, by use of Digipods.

Various forms of digital media are stored in a remote database Digisource 20, and their usage is also controlled by the services provided by the Digisource 20. The services include digital content management, secured distribution of digital media, and protection technologies contained in software applications. Digisource 20 is preferably fully compatible with multiple hardware platforms that include, but are not limited to, personal computers, game consoles, and wireless handheld devices. Digisource 20 also preferably operates through numerous distribution methods that include, but are not limited to, Internet download, digital broadcast, CD-ROMS, and compact flash memory.

Digibase A 22 may consist of a hardware platform, such as a personal computer, that serves as a utilization device for the digital media. In order to utilize the digital media provided by the Digisource 20, the hardware platform establishes communication with the Digisource 20 service provider and receives software to convert the personal computer to a Digibase. Once converted, Digibase A 22 is able to consume on a pay-per-play basis digital media that is transferred from the Digisource 20 to the Digibase A 22. The Digibase A 22 includes software which allows access to, and execution of, the digital media distributed by the Digisource 20.

For the Digibase A 22 to utilize digital media, it receives a Digipod A 30 which is a software application that effectively acts as a storage device for digital content. Digipod A 30 may include the digital media content ordered by Digibase A 22, restrictions on the duration of use of the digital media, the cost scheme for purchasing usage of the content, and information regarding the history of the Digipod A 30. Digibase A 22 utilizes the content in a Digipod A 30. Examples of digital media that may be included in Digipod A 30 are music, movies, and video games.

The pay-per-play basis of digital media consumption is governed by credits. A credit is a unit of rights for a given piece of content and is purchased from the Digisource 20. The utilization of particular digital media content requires the consumption of credits, with the Digipod A 30 including information on how much use equates to a single credit. A credit allows use of the digital media for a limited period of time or for a particular number of uses. Examples of the amount of use a credit provides include three songs per credit, one movie per credit, or one hour of game playing per credit. Other conditional limits and restrictions, such as three plays of a song, three “lives” per video game, etc., may be imposed by the content owners that are not simply restricted to duration or time. The Digipod A 30 contains the information, which is determined by the Digisource 20, that regulates how much use is allowed per credit. The credit is restricted to the Digibase A 22 that the Digipod A 30 is stored on, or the Digipod A 30 it is being transferred with. Credits cannot be duplicated. New credits can only be created by the Digisource 20. Safeguards to prevent the duplication of credits may be provided by any suitable mechanism, including restrictions in a Digipod A 30 or mandatory communication with Digisource 20 to confirm and register the transfer of the credits in a database.

Credits may be distributed to Digibases 22, 24, 26 either within Digipods 30, 32, 34, 36, or by direct connection to a Digisource 20. Users may transfer credits to other users by either method as well. It is preferable for credits to not be dependent on Digipods 30, 32, 34, 36, such that consumers may pass content among themselves freely (with the option of giving or selling usage rights to each other—such rights may be transferred via the Digisource 20 or via Digipods 30, 32, 34, 36), but only pay for it when they use the content. For example: User A gives content to User B at school. In order for User B to use the content, he/she either needs to obtain credits from User A (either included in the Digipod 30, 32, 34, 36 with the content or via a transfer of rights using the Digisource 20, which is accessible when User B gets home from school), or he/she needs to pay for credits directly to the Digisource 20.

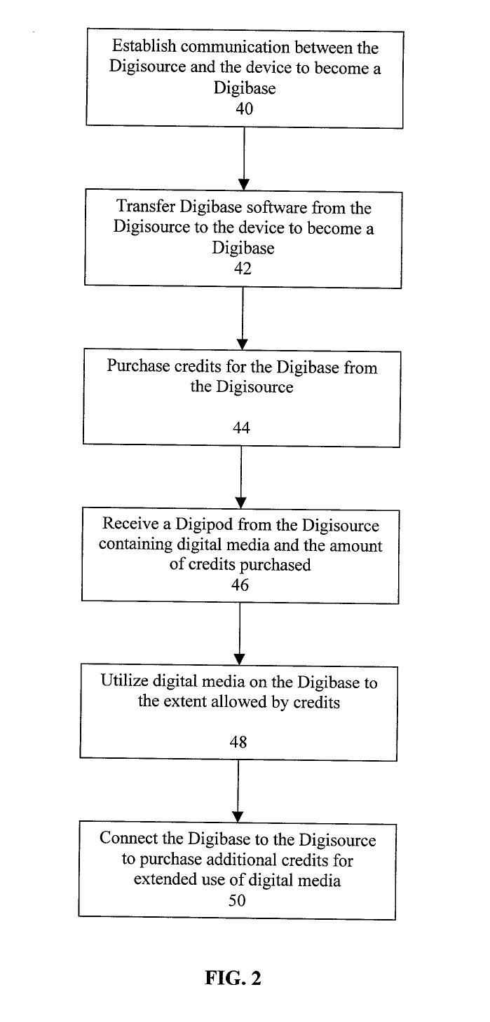

FIG. 2 illustrates a sample operation of a distribution of digital media as illustrated in FIG. 1 where the digital media is transferred from a Digisource 20 to a Digibase A 22, including the steps of creating and utilizing a Digibase A 22. First, communication between the Digisource 20 and the hardware platform that becomes a Digibase A 22 is established 40. The communication may be in any fashion including direct download, through Internet servers, or via disk. The hardware platform then receives 42 the Digibase software from the Digisource 20. Execution of the software converts the hardware platform into a Digibase A 22. The Digibase A 22 may now communicate fully with the Digisource 20 so that credits may be purchased 44 and a Digipod A 30 may be received 46. Credits may be purchased from the Digisource 20 by any suitable mechanism including direct downloads, through Internet servers, or via disk. The Digibase A 22 user selects the particular digital media to be received and orders it from the Digisource 20. The Digisource 20 satisfies the order by transferring 46 a copy of the digital media, along with any credits purchased during the transaction, into a Digipod A 30 to the Digibase A 22. The Digibase A 22 may then utilize 48 the digital media at whatever time is convenient for the user to the extent allowed by the available credits. Credits may be consumed independently of communication with the Digisource 20, as the Digibase A 22 monitors the use of the digital media. To receive additional credits, the Digibase A 22 must reestablish communication with the Digisource 20 and purchase 50 additional credits that are transferred to the Digibase A 22 in a new Digipod A 30.

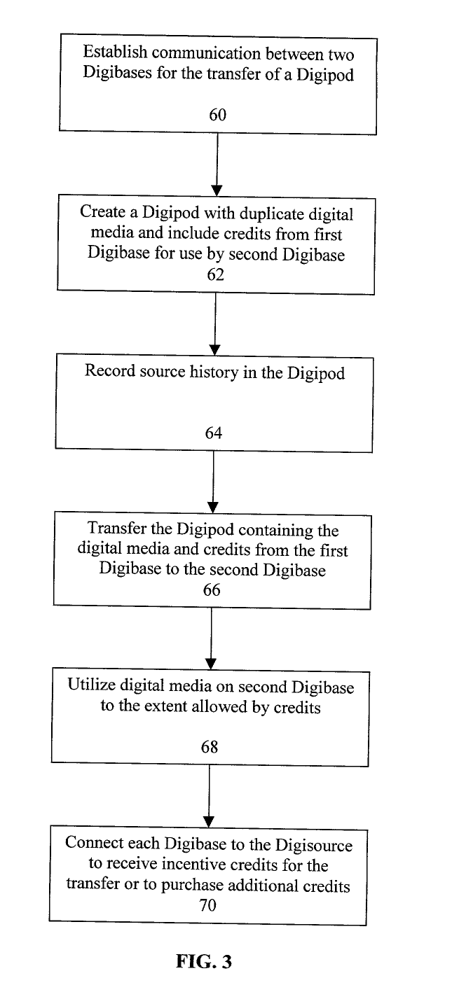

FIG. 3 illustrates a sample operation of a distribution of digital media as illustrated in FIG. 1 where the digital media is transferred from a first Digibase A 22 to a second Digibase B 24 independently of the Digisource 20. FIG. 1 also demonstrates the transferring of Digipods B 32, C 34, and D 36 with Digibases B 24, C 26, and A 22, respectively. To transfer a Digipod B 32 from Digibase A 22 to B 24, communication between the two is established 60. This communication may also be performed using any suitable mechanism, including a direct connection, network connection, wireless connection, etc. Once file sharing capability has been established between the two Digibases, the first Digibase A 22 creates 62 a Digipod B 32 by duplicating or pasting its copy of the digital media into the Digipod B 32. Credits may also be included 62 in the Digipod B 32. Also recorded in the Digipod B 32 is the source history of the digital media 64. This record keeps track of all the Digibases on which particular digital media has been installed and is transmitted to the Digisource 20 when the Digibase B 24 containing the record establishes communication with the Digisource 20.

After the Digipod B 32 has been successfully transferred 66 to the second Digibase B 24, the Digibase B 24 can utilize 68 the digital media contained in the Digipod B 32 to the extent allowed by the credits in the Digipod B 32 and in the Digibase B 24 prior to the transfer. Once the second Digibase B 24 has depleted its stored credits, it can establish 70 communication with the Digisource 20 to purchase additional credits. The process of file sharing among Digipods may be repeated in a virtually unlimited fashion, as shown with Digibase C 26 and Digibase A 22. However, Digibases cannot duplicate credits, nor can Digibases be copied to include credits. The Digisource 20 creates all credits and distributes them to Digibases either directly, as with Digibase A 22, or indirectly through other Digibases, as with Digibase B 24 and Digibase C 26.

The distribution system may include options such as providing limited free use of a digital medium for promotional purposes. Another option is to allow unlimited use of a digital medium on one particular Digibase A 22 once a predetermined number of credits are purchased for, or consumed utilizing, the individual digital medium. By reaching the predetermined number of credits, the Digibase A 22 user has acquired purchase-rights that are limited to the particular Digibase A 22, or the purchase-rights may be transferred by a Digipod B 32 to another Digibase B 24. An incentive program may be created by the Digisource 20 to encourage peer-to-peer file sharing among Digibase users, whereby the transferor and the transferee both receive additional credits for their file sharing. These additional credits are provided only by the Digisource 20; therefore, the individual Digibases need to reestablish 70 communication with the Digisource 20 to receive the credits. Since the Digipod records the history of the digital media, the Digisource 20 can prevent abuse of the incentive credits by limiting the number of free credits a single Digibase can receive for sending or receiving a single item of digital medium.

An example application of the preferred embodiment of the present invention is where an owner of a personal computer wants to play a video game offered by Digisource 20. The owner connects the personal computer to the Digisource 20 via an Internet server and downloads the software to convert the personal computer into a Digibase A 22. The individual may then select and order the video game from the Digisource 20 database. The individual may also purchase credits, for example ten credits, from the Digisource 20 during the same transaction. Once the transaction is complete, the Digisource 20 sends Digipod A 30, which includes the video game content and the ten credits, to Digibase A 22. The owner of Digibase A 22 may play the video game for ten hours if each credit allows one hour of video game play. The Digibase A 22 executes the video game and monitors the duration of use independently of any communication with the Digisource 20.

If the owner of Digibase A 22 plays only five hours and decides to share the game with a friend, he may establish communication with his friend's personal computer and send the computer software to convert it into Digibase B 24. Once Digibase B 24 is active, Digipod B 32, containing the video game content and the five credits, is sent from Digibase A 22 to Digibase B 24. Digibase B 24 may now play the video game for five hours and Digibase A 22 has no remaining credits with which to play the game. Assuming the Digisource 20 service provides incentive credits for file sharing, both Digibase A 22 and Digibase B 24 may receive certain amounts of credits from Digisource 20 the next time they establish communication with Digisource 20. If the same video game software is then shared with Digibase C 26 and then Digibase A 22, no incentive credits are awarded for the second transfer to Digibase A 22. Because the Digipods B 24, C 34, and D 36 all kept records of the file's history, the Digisource 20 will recognize that Digipod A 22 had already received incentive credits for that particular video game content and will not award any credits for Digipod D 36. All the Digibases are also independently adapted to connect to Digisource 20 for the transfer of digital media and the purchase of credits. Incentive credits should only be rewarded by the Digisource 20 when content has first been transferred from User A to User B, and then used by User B where User B has spent a number of credits (specified by the Digibase 22, 24, 26) on that content.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A digital media distribution system, comprising:
a distribution center;
an utilization device that communicates with and receives digital media from the distribution center; and
restrictions transferred with the digital media that limit use of the digital media on the utilization device independently of the distribution center.

2. The digital media distribution system according to claim 1, wherein the restrictions include discrete units of time credits provided by the distribution center.

3. The digital media distribution system according to claim 1, wherein the restrictions include discrete units of time credits purchased with the utilization device from the distribution center at time of transfer of the digital media.

4. The digital media distribution system according claim 1, wherein the restrictions include discrete units of time credits purchased with the utilization device from the distribution center during subsequent communication between the utilization device and the distribution center.

5. The digital media distribution system according to claim 1, wherein the restrictions include discrete units of time credits purchased with the utilization device from the distribution center and the restrictions that limit the use of the digital media are removed on a particular utilization device once a preset number of units of time credits are purchased by the utilization device from the distribution center.

6. The digital media distribution system according to claim 1, wherein the digital media is a video game.

7. The digital media distribution system according to claim 1, wherein the digital media is received from the distribution center by communications with an Internet server.

8. A digital media distribution system comprising:
a distribution center;
a first utilization device that communicates with and receives digital media from the distribution center;
a second utilization device that communicates with and receives the digital media from the first utilization device; and
restrictions transferred with the digital media that limit use of the digital media on the second utilization device independently of the distribution center and the first utilization device.

9. The digital media distribution system according to claim 8, wherein the restrictions include discrete units of time credits, and a transfer of the digital media and the restrictions results in a combined number of units of time credits for both the first utilization device and second utilization device no greater than a number of units of time credits on the first utilization device prior to the transfer.

10. The digital media distribution system according to claim 8, wherein the restrictions include discrete units of time credits purchased by the first utilization device from the distribution center.

11. The digital media distribution system according to claim 8, wherein the restrictions include discrete units of time credits purchased by the second utilization device from the distribution center.

12 The digital media distribution system according to claim 8, wherein the restrictions include discrete units of time credits and both the first utilization device and the second utilization device receive additional units of time credits by transmission of the digital media from the first utilization device to the second utilization device.

13. The digital media distribution system according to claim 8, wherein the restrictions record a chain of distribution among utilization devices.

14. The digital media distribution system according to claim 8, wherein the digital media is received from the distribution center by communications with an Internet server.

15. The digital media distribution system according to claim 8, wherein the transmission of digital media from the first utilization device to the second utilization device is conducted by placing the digital media and the restrictions on a storage disk that may be transported from the first utilization device to the second utilization device.

16. The digital media distribution system according to claim 12, wherein the discrete units of time credits may be received only by communication with the distribution center.

17. The digital media distribution system according to claim 9, wherein the discrete units of time credits may be transmitted, without the digital media, from the first utilization device to the second utilization device so that a combined number of units of time credits remains unchanged.

18. The digital media distribution system according to claim 8, wherein the digital media is a video game.

19. An utilization device to employ digital media, comprising:
a computer-readable medium; and
computer-readable code, stored on the computer-readable medium, having instructions to
receive the digital media from a distribution center to the utilization device,
monitor use of the digital media on the utilization device, and
restrict the use of the digital media on the utilization device independently of the distribution center.

20. The utilization device according to claim 19, wherein the use of the digital media is measured in discrete units of time credits that are purchased by the utilization device from the distribution center.

21. The utilization device according to claim 19, wherein the computer-readable code is received from the distribution center by communications with an Internet server.

22. The utilization device according to claim 19, wherein the digital media is a video game.

23. An utilization device to employ digital media, comprising:
a computer-readable medium; and
a computer-readable code, stored on the computer-readable medium, having instructions to
transfer the digital media from a first utilization device to the utilization device,
monitor use of the digital media on the utilization device, and
restrict the use of the digital media on the utilization device independently of a distribution center that originally transferred the digital media and the computer-readable code to the first utilization device.

24. The utilization device according to claim 23, wherein the use of the digital media is measured in discrete units of time credits that are purchased by the utilization device from the distribution center.

25. The utilization device according to claim 23, wherein the use is measured in discrete units of time credits, and a transfer of the digital media and the restrictions results in a combined number of units of time credits for both the first utilization device and utilization device no greater than the number of units of time credits on the first utilization device prior to the transfer.

26. The utilization device according to claim 23, wherein the use is measured in discrete units of time credits and both the first utilization device and the utilization device receive additional units of time credits, independent of units of time credits transferred between the first utilization device and the utilization device, due to transfer of the digital media from the first utilization device to the utilization device.

27. The utilization device according to claim 23, wherein the computer-readable code is received from the distribution center by communications with an Internet server.

28. The utilization device according to claim 23, wherein the digital media is a video game.

29. A digital media distribution system comprising:
a distribution center;
a first utilization device to employ digital media and to communicate with and receive the digital media from the distribution center by communication with an Internet server;
a second utilization device to employ the digital media and receive the digital media from the first utilization device by communication with an Internet server; and
restrictions, which include discrete units of time credits purchased by the first utilization device from the distribution center and a chain of distribution among utilization devices, transferred with the digital media that limit use of the digital media on the second utilization device independently of the distribution center and the first utilization device.

30. The digital media distribution system according to claim 29, wherein the digital media is a video game.
